(19) United States
(12) Patent Application Publication
(10) Pub. No.: US 2017/0332049 A1
(43) Pub. Date: Nov. 16, 2017

(54) INTELLIGENT SENSOR NETWORK

(71) Applicant: Tijee Corporation, Bellevue, WA (US)

(72) Inventor: Yong Zhang, Bellevue, WA (US)

(21) Appl. No.: 15/469,262

(22) Filed: Mar. 24, 2017

Related U.S. Application Data
(60) Provisional application No. 62/335,702, filed on May 13, 2016.

(51) Int. Cl. H04N 7/18; H04W 4/00; H04L 29/08; G01J 5/02; G01H 17/00; H04W 84/18

(52) U.S. Cl. CPC H04N 7/181; H04L 67/125; H04W 4/008; G01H 17/00; H04L 67/02; G01J 5/025; H04W 84/18

(57) ABSTRACT

A sensor network with multiple wireless communication channels and multiple sensors for surveillance is disclosed. The network may enable object detection, recognition, and tracking in a manner that balances low-power monitoring and on-demand high-speed data transferring.

### RELATED APPLICATION

This application claims priority under 35 U.S.C. §119 to U.S. Provisional Application No. 62/335,702, filed May 13, 2016, entitled “Intelligent Hybrid Sensor Network with Multiple Wireless Communication Channels,” the disclosure of which is incorporated by reference herein in its entirety.

### BACKGROUND

The disclosed technology is in the technical field of surveillance sensor networks. More particularly, the disclosed technology is in the technical field of self-organized intelligent networks that carry multiple wireless communication channels and comprises hybrid sensors.

Conventional surveillance systems, which consist of individual sensors and/or cameras, need labor-intensive professional installation and configuration, and they result in a high rate of false alarms and/or missed alarms.

### BRIEF DESCRIPTION OF THE DRAWINGS

FIG. 1 illustrates one embodiment of a wireless sensor network of the disclosed technology used in surveillance applications.

FIG. 2 is a block diagram illustrating an exemplary architecture of a simple network node in accordance with some implementations of the disclosed technology.

FIG. 3 is a block diagram illustrating an example architecture of a network node in accordance with some implementations of the disclosed technology that contains a video/image capturing processor.

FIG. 4 is a block diagram illustrating an exemplary architecture of a controller node in accordance with some implementations of the disclosed technology.

FIG. 5 is a flow diagram illustrating a network node initialization process in accordance with some implementations of the disclosed technology.

FIG. 6 is a diagram that illustrates how spatial topology of an example network is determined in accordance with some implementations of the disclosed technology.

FIG. 7 shows an exemplary command set in accordance with some implementations of the disclosed technology.

### DETAILED DESCRIPTION

The disclosed technology is directed to a self-organized intelligent wireless network with multiple wireless communication channels and hybrid sensors. The self-organized wireless network provides reliable data collection service with less labor-intensive installation and/or configuration requirements. It also provides the flexibility of easy addition and removal of data collection points (network nodes) even after the initial deployment.

The disclosed technology includes both a low-power Internet of Things (IoT) communication channel and a high-speed wireless communication channel, such as 2.4 GHz/5 GHz Wi-Fi. High-power-consuming operations can be activated on demand whenever a corresponding command is received from a low-power communication channel, and this results in a balance between power-saving and high-speed transferring of video/image data. Besides the power-saving benefit for a limited power supply scenario, the disclosed technology also provides the benefit of interoperability with other IoT devices with the integrated IoT routing and/or gateway functions.

Hybrid sensors provide multidimensional information about the environmental variables for applications to increase the accuracy of object detection, recognition, and tracking.

The disclosed technology may be implemented as an integral intelligent sensor network that automatically determines the location of end-point network nodes in virtual spatial coordinates. This helps the system recognize and track an object's movement in physical space.

The disclosed technology can be deployed in both indoor and outdoor surveillance zones. It can be used either independently or as part of other systems, including but not limited to home security systems and home automation systems.

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but no other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

Various examples of the invention will now be described. The following description provides certain specific details for a thorough understanding and enabling description of these examples. One skilled in the relevant technology will understand, however, that the invention may be practiced without many of these details. Likewise, one skilled in the relevant technology will also understand that the invention may include many other obvious features not described in detail herein. Additionally, some well-known structures or functions may not be shown or described in detail below, to avoid unnecessarily obscuring the relevant descriptions of the various examples.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

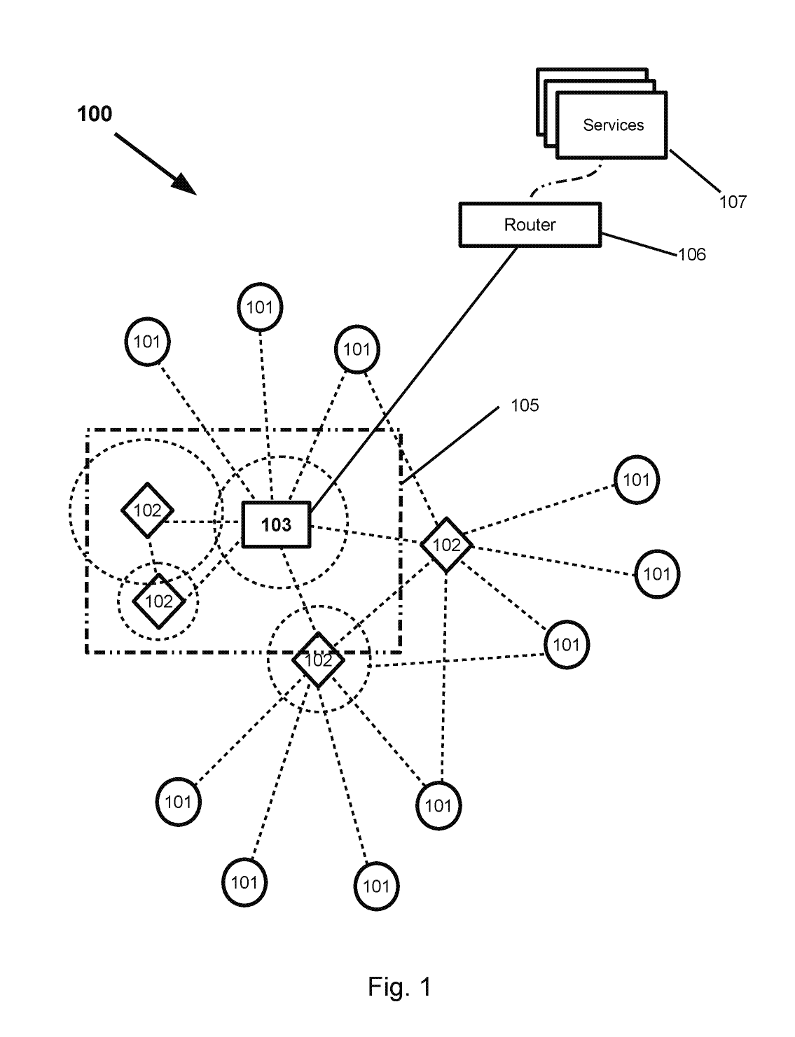

FIG. 1 depicts one embodiment of a wireless intelligent sensor network 100, which contains one or more simple nodes 101, one or more complex nodes 102, and one or more controller nodes 103. FIG. 1 also has a boundary 105 that is the boundary of the surveillance field, such as a residential house. If there are multiple controller nodes 103 in the system, one of them can be elected as a main controller, while others can operate as slave controllers for sub-networks.

The controller node 103 coordinates and manages other network nodes for radio frequency (RF) selection, routing node assignment, network node joining, command dispatching, and other system-level management functions. The controller node 103 may operate as a gateway to receive and send data from and to web/cloud services 107 through a wired or wireless router 106. Surveillance applications can be deployed on the controller node 103. Node 103 may send environment data including preprocessed intermedia data, collected either by network nodes, controller node itself, or both, to web/cloud Services 107. Web/cloud services may detect and recognize objects by running heavy processing algorithms (such as machine learning, or other algorithms/methods). Web/cloud services may communicate the detection and recognition results back to controller node 103 and its surveillance applications. The controller node 103 itself may also have internally integrated sensors to collect environmental data, such as sound, motion, video, images, etc.

The simple node 101 contains at least two sensors to collect different environmental data, such as motion, sound, temperature, vibration, etc. Either proactively or when requested, the simple node 101 may transfer locally collected data to the controller node 103 via one of the low-power IoT communication channels, such as the ZigBee protocol, the Bluetooth Low-Energy (BLE) protocol, the Z-Wave protocol, Sub-1 GHz, etc., either directly or indirectly via other routing nodes (e.g., simple or complex nodes.). The simple node 101 can receive commands from the controller node 103 through IoT communication channels to operate internal sensors, attached devices, and/or other IoT devices that are nearby.

A complex node 102, which provides functions similar to the simple node 101, contains at least one additional video/image capturing processor. Besides the IoT communication channel, the complex node 102 wirelessly transfers images and/or video data through a high-speed communication channel, such as a 2.4 GHz/5 GHz Wi-Fi channel, either directly or indirectly via other routing nodes (e.g., complex nodes).

As shown in FIG. 1, the whole network carries at least two internal wireless communication channels. One is a low-power IoT channel to transfer small-sized data (such as commands and temperature readings) with low-speed (e.g., less than 1 Mbit/Second) and to operate other IoT devices nearby; another is a high-speed (e.g., over 1 Mbit/Second) wireless channel (e.g., Wi-Fi) to transfer massive data (e.g., real-time image/video streams that are orders of magnitudes larger in size than the small-sized data). An example of data transferred over low-power IoT channel is the command to read power status of a network node and its response from the network node to the controller node. The sizes of both the command and response could typically be less than 1 kbyte. Such a communication between a controller node and a network node could be configured to be conducted once every 5 minutes. An example of data transferred over high-speed wireless channel is real-time 1080P video streaming encoded in H.264 over Real-Time Transport Protocol (RTP) that requires 5-8 MBPS transport bandwidth. With two communication channels, the disclosed technology can balance both power-saving and data transfer throughput because normal communications can be transferred through the IoT channel while high-power-consuming operations can be executed on demand. Multiple communication channels also help each other establish the initial connection, detect or recover from failures, and adapt to dynamic network changes. For reliable distributed communication, some of the network nodes will be selected by the controller node for data routing.

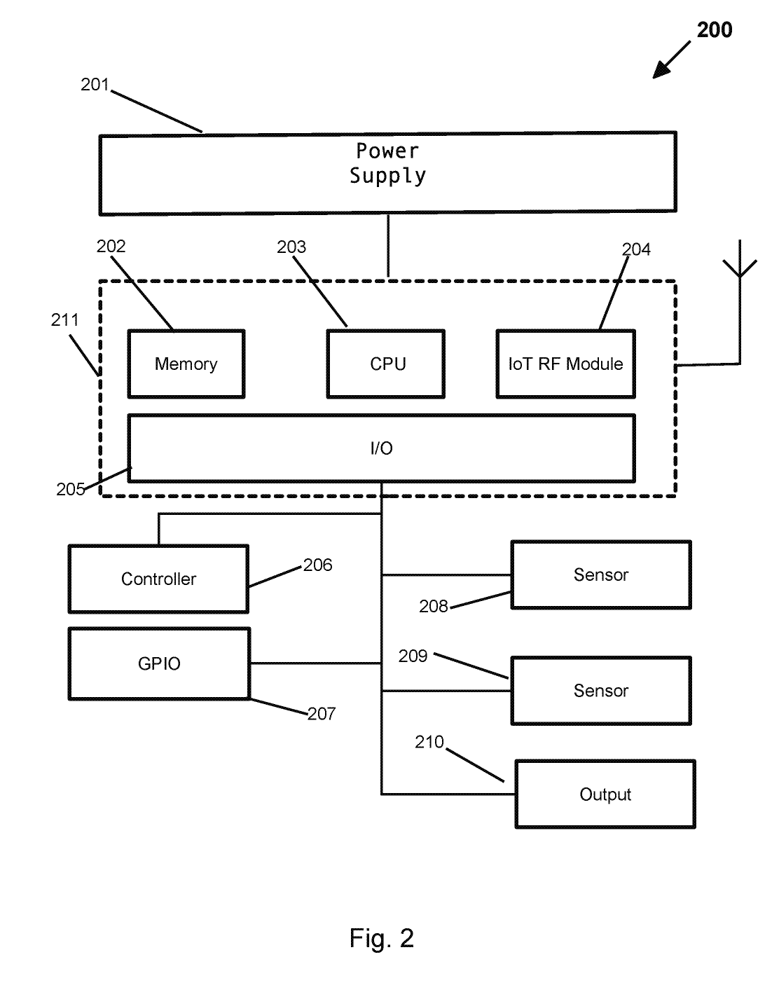

FIG. 2 is a block diagram illustrating an exemplary composition of a simple node 200 (e.g., simple node 101 in FIG. 1) without a video capturing processor. The simple node 200 contains at least a power supply module 201, a micro-controller unit (MCU) 211, a passive infrared (PIR) sensor and/or PIR sensor array 208, a sound sensor 209 (e.g., a microphone), an optional speaker and/or buzzer component 210, and a variable number of other input/output (I/O) ports, such as I/O ports 206, 207, that can connect to other sensors or electronic components (e.g., LED lights). The MCU 211 can be made of a group of any number of individual electronic components or integrated chips (ICs) and it contains at least a memory 202, a central processing unit (CPU) 203, an IoT RF module 204, and input/output (I/O) module 205. The memory may include nonvolatile flash memory or volatile random access memory (RAM).

Sensors such as sensors 208, 209 collect physical environmental variables (e.g., temperature, motion, or sound). If triggered by local environment changes or requested by a controller node (e.g., node 103 in FIG. 1), the MCU 211 may transfer collected data and/or pre-processed data in packages to the controller node via the IoT RF module 204. The IoT RF module implements at least one of the low-power IoT communication protocols, such as ZigBee, BLE, etc.

The simple node 200 can receive commands and data from controller node(s) (e.g., node 103 in FIG. 1) via the IoT RF module 204, for example, to update a sound energy threshold for burst event detection, to collect environmental temperature data, or to turn on or turn off LED lights, etc. If not running in power-saving mode, the simple node 200 also can be selected by the controller node or an IoT coordinator to act as an IoT routing node.

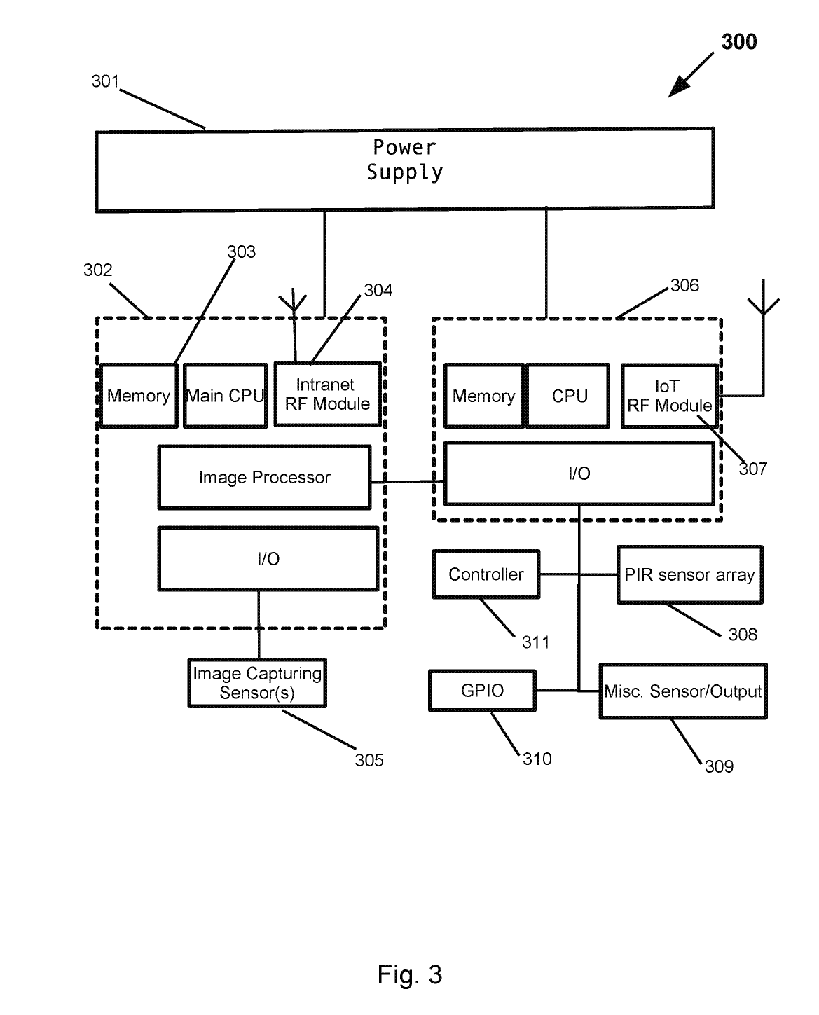

FIG. 3 is a block diagram that illustrates an exemplary architecture of a complex node 300 (e.g., complex node 102 in FIG. 1) with a video capturing processor. The complex node 300 includes at least a power supply module 301, a micro-controller unit (MCU) 302, a video/image capturing sensor 305, an IoT micro-controller unit (IoT MCU) 306, a passive infrared (PIR) sensor and/or PIR sensor array 308, and a variable number of other input/output (I/O) ports, such as Misc. Sensor/Output 309, GPIO (general-purpose input/output) 310, and Controller 311, which are connected to other sensors or controlled electronic components (e.g., LED lights, infrared LEDs). The MCU 302 and IoT MCU 306 can be composed of any number of individual electronic components and integrated chips, and they each includes at least a memory, a Main CPU (central processing unit) 303, a wireless radio frequency (RF) module 304, and an input/output (I/O) module. The MCU 302 also includes at least one image processor for video encoding/decoding and other image operations. The I/O components of the two MCUs may connect to each other directly or be merged as a single shared I/O component. In either case, the connected devices and/or sensors may connect to either one of these MCUs.

Still referring to FIG. 3, there are two different wireless RF modules in the complex node 300. The Intranet Wi-Fi RF module 304 is used for high-speed data transfer of video/image data, and the IoT RF module 307 implements an IoT communication protocol for transferring low-speed data with low power consumption. Similar to a simple node 200, a complex node 300 also can be auto-selected as a routing node in either wireless communication channel.

There is at least one low-power sensor, that can operate without stop for more than 1 year without changing battery (such as a PIR), inside a complex node 300. The PIR sensor array 308 collects physical environmental variables regularly, e.g., temperature, motion, sound, etc., and it can be either activated into full-data-collection mode by local environmental variable changes detected by the low-power sensor or can be activated as requested by a controller node. In a similar way, at least one video/image capturing sensor 305 inside a complex node 300 can be activated to switch from power-saving mode to full-data-collection mode to collect real-time image data to be processed by an image processor and/or the main CPU 303. In some embodiments, video/image data are always transferred through a high-speed communication channel via the RF module 304, and low-speed data can be transferred through either communication channel when available.

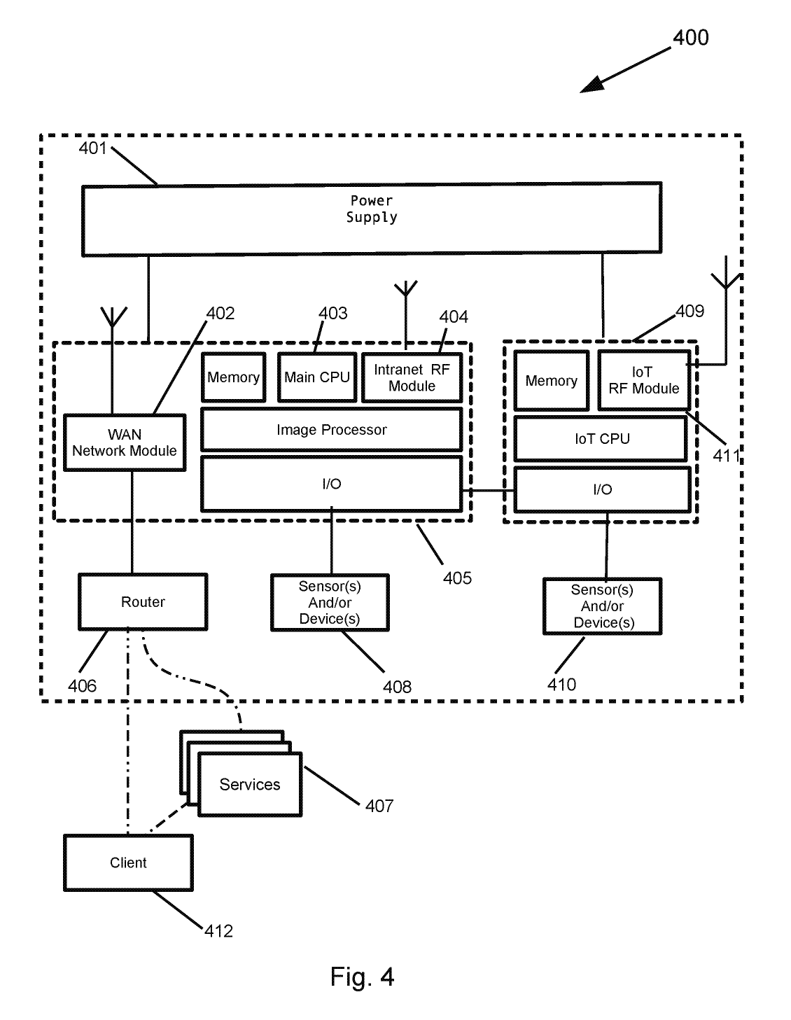

FIG. 4 is a block diagram that illustrates an exemplary composition of a controller node 400 (e.g., controller node 103 in FIG. 1) that includes at least a power supply module 401, a general micro-controller unit (MCU) 405, and an IoT micro-controller unit (IoT MCU) 409. From the aspect of networking, the controller node 400 plays the router/coordinator role for the self-organized IoT wireless network and/or the high-speed Intranet wireless network. It is responsible for selecting RF protocols, for managing the joining and leaving of network nodes, for security control, and for internal data routing. The controller node 400 may also play the role of gateway for communications with web/cloud services 407 via an Internet router device 406. Therefore, the controller node 400 can be equipped with at least three network modules: one IoT RF module 411, one Intranet RF module 404, and one wired or wireless WAN network module 402.

The main CPU 403 runs applications receiving collected data from sensors of network nodes and then may collaborate with web/cloud services 407 for advanced processing, such as object detection, recognition, tracking, and abnormal scene detection. Per internal instructions or requests from a client 412 (e.g., a remote mobile application), it may send operation commands to network nodes and/or other IoT devices that have joined the network. It may also compose real-time video/audio streams, possibly aided by one or more image/graphic processor(s), when requested to do so by the client 412 and/or the web/cloud services 407.

Similar to both simple nodes 200 and the complex nodes 300, various sensors and devices 408 and 410 may be included within the controller node, such as speakers, microphones, and video/image capturing sensors.

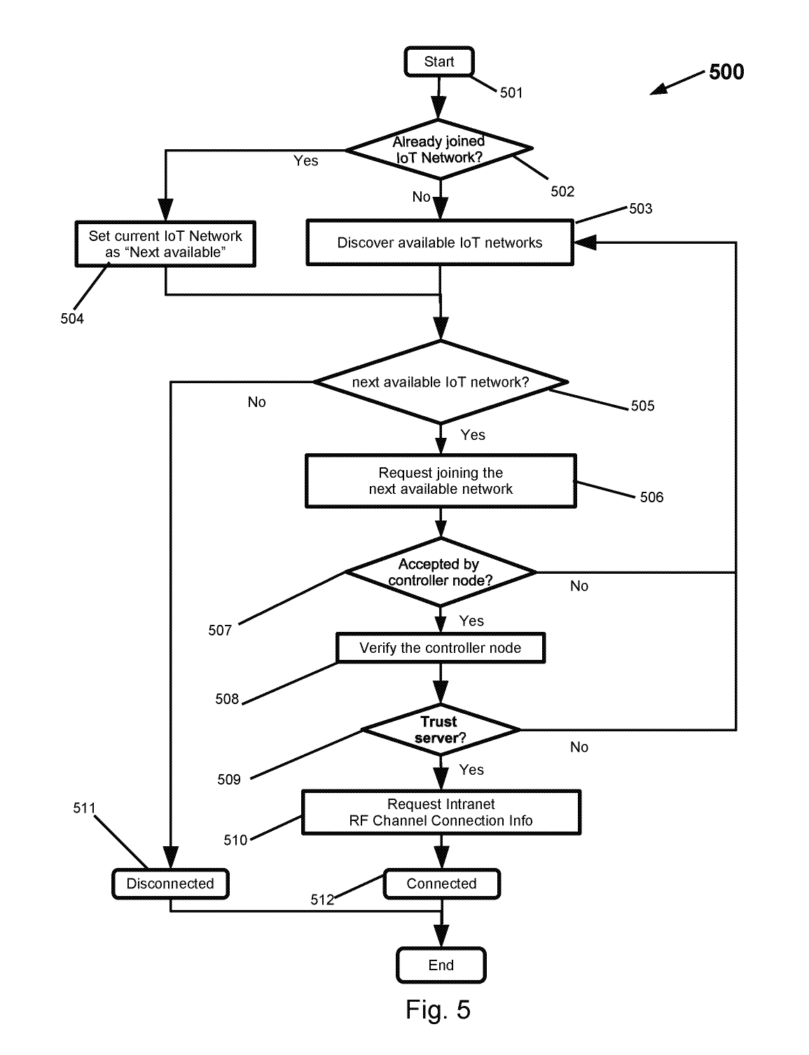

FIG. 5 is a flow diagram that shows an exemplary initialization process 500 for a simple node 200 or complex node 300.

A node starts initialization at step 501, and then at IoT network check step 502 detects whether this node has already joined an existing IoT network. If so, the node will execute step 504 to set that IoT network as “Next Available” IoT network candidate. Otherwise, it executes IoT network discover step 503 to choose the next available IoT network candidate. Decision step 505 checks whether there is any available IoT network candidate to try joining. If no, then the node reaches the “Disconnected” state step; if yes, join request step 506 is executed to send a request with the node's unified Hardware Identity (HID) and embedded original signature to an IoT network coordinator (e.g., the controller node 103 in FIG. 1) directly or via IoT routing node(s) nearby. Afterwards, decision step 507 checks whether the request has been accepted by controller node 103 or not by parsing and processing the response from controller node 103. If the join request has not been accepted, the initialization process 500 will proceed to IoT network discover step 503 to select next IoT network candidate to connect to. Otherwise, the initialization process 500 will proceed to verification step 508 to conduct the verification of the trustworthiness of the controller node 103, e.g., verify that a digital signature contained in the response (if present) from the controller node 103 is authentic from a trustworthy controller node 103 by decrypting it using the corresponding trustworthy public key. Decision step 509 checks whether the trustworthiness verification step 508 has been passed or not. If not, then this IoT network cannot be used and the initialization process 500 will proceed to IoT network discover step 503 to select next IoT network candidate to connect to. Otherwise, the initialization process 500 will proceed to step 510 which is an optional step only for those nodes with a high-speed communication capability to obtain information to establish such a communication channel. Afterwards, the node's state will be changed to “Connected” at step 512. Except for optional step 510, all other communication steps mentioned in this diagram are performed via the low-power channel following IoT network protocols.

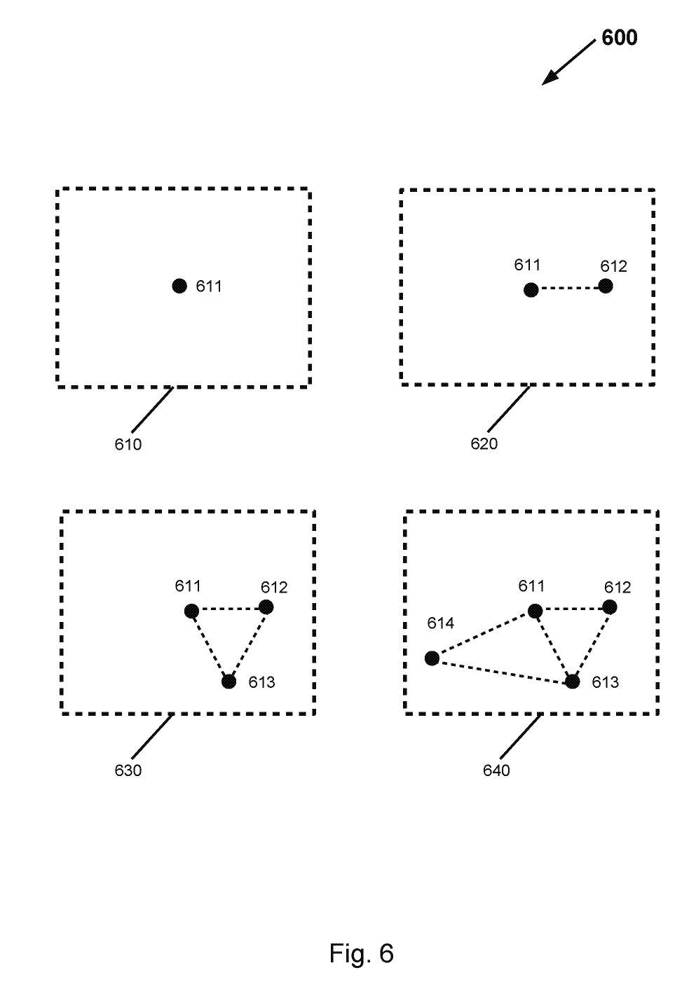

FIG. 6 is a diagram 600 that illustrates how spatial topology of an exemplary network of the disclosed technology is determined. The communication described in this diagram can be performed via either the low-power channel (e.g. ZigBee) or high-speed channel (e.g., Wi-Fi). At stage 610, controller node 611 (e.g., controller node 103 in FIG. 1) is the first node in the network. It sorts all reachable nodes by the measured spatial distance between each of them and the controller node 611, resulting in a sorted list consisting of undetermined but reachable nodes with ascending distances between each of these nodes and the controller node 611. At stage 620, the nearest neighbor node 612 can be determined by selecting the first node from the sorted list. The distance between nodes 611 and 612 represents measurement of the relative spatial relationship between these two nodes. Node 612 joins first node 611 into this partially constructed network. All the reachable nodes from node 612 will also be added into the sorted list in an ascending order of their respective shortest distance to this partially constructed network (i.e., the shortest distance to any one of the existing node in this partially constructed network). At stage 630, the next node 613 is fetched from the sorted list. With the distance information between node 613 and the partially constructed network consisting node 611& node 612, the relative spatial topology of node 613 against node 611 & node 612 could possibly be determined. Similarly, at stage 640, node 614 is the next reachable node from the sorted list located by the two nodes (611 and 613) with the shortest distance to the partially constructed network. Stage 640 can be repeated until all nodes in the sorted list have been processed. For unreachable isolated nodes that cannot be found as nearest neighbors from determined nodes, the spatial topology determination starts from a place outside of the determined spatial scope and proceeds with a same or similar nearest neighbor identification process until all nodes have been located in the spatial topology. This spatial topology determination may be executed or otherwise implemented on at predetermined time intervals or whenever a new node (including other IoT devices compatible to the system) joins the network.

In order to measure the spatial distance between two nodes for spatial topology determination, one node first broadcasts sound signals and/or radio frequency (RF) signals to another. Based on the signal travel time and/or the signal intensity level loss during the trip, the distance will be estimated based on wave travel factors. For example, signal intensity fades with formula K*1/r², where r is the distance from the source of signal and K is the coefficient of attenuation. The sound wave travel speed in air is about 346 meters per second at 25° C. The measuring process may be conducted multiple times to calculate the optimal estimated spatial distance between two nodes.

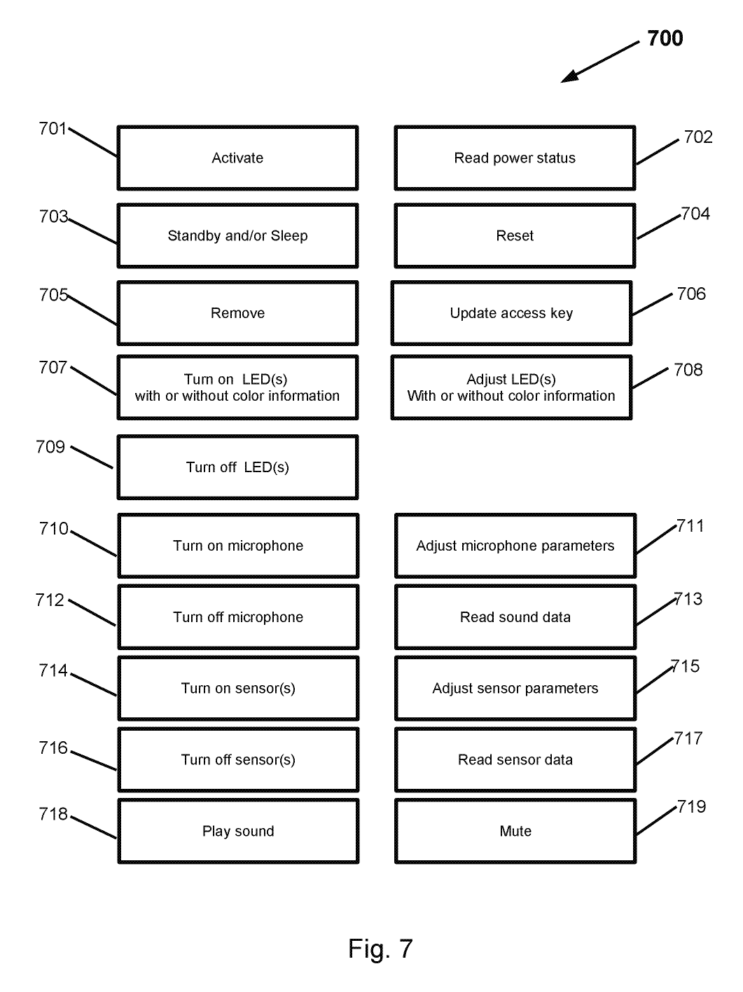

FIG. 7 shows an exemplary command set 700 for implementing at least some of the methods, processes or functionalities disclosed herein. In response to detected events or requests from services or users (e.g., interacting with client device(s)), a controller node may send operational commands to desired nodes. Command 701 requests the node to resume regular operations from power-saving mode; command 702 requests the node to report its current power supply and/or battery status; command 703 requests the node to enter into power-saving mode; command 704 requests the node to reset its state; command 705 notifies the node that it has been removed from the network; command 706 notifies the node to use a new updated network access key; command 707 requests the node to turn on its attached LED light, if applicable; command 708 requests the node to adjust its attached LED light intensity/colors if applicable; command 709 requests the node to turn off its attached LED light, if applicable; command 710 requests the node to turn on its attached microphone if it is so equipped; command 711 notifies the node to adjust its microphone parameters, if applicable; command 712 requests the node to turn off its attached microphone if it is so equipped; command 713 requests the node to send its cached and/or real-time collected sound data back, if applicable; command 714 requests the node to turn on one or more of its attached sensors, if applicable; command 715 requests the node to apply new parameters for desired sensors, if applicable; command 716 requests the node to turn off one or more of its sensors if it is so equipped; command 717 requests the node to send its cached and/or collected real-time sensor data, if applicable; command 718 requests the node to play a desired sound if there is a speaker attached; and command 719 requests the node to mute its speaker, if applicable. Please note that not all nodes support all of those commands, and some commands can be combined as a single command in specific applications.

The advantages of the disclosed technology include, without limitation, supporting both high-speed transfer of collected video/image data on demand and transfer of data collected by various other sensors utilizing a low-power-consuming channel. Furthermore, the disclosed technology can be implemented to construct a self-organized wireless network carrying multiple protocols with minimal administrative work required, which lowers the network jam effects with normal home wireless bandwidth. Also, the disclosed technology can be implemented to establish a spatial topology of network nodes that provides a basis for detecting, recognizing, and tracking moving objects in the covered spatial area. Furthermore, the disclosed technology may utilize different types of sensors that can increase the accuracy of object detection/recognition and/or tracking.

In a broad embodiment, the disclosed technology is directed to a wireless network for environmental variable data collection. At least a self-organized sensor network with multiple wireless communication channels and hybrid sensors for surveillance applications is disclosed. The disclosed technology enables highly precise object detection, recognition, and tracking based upon multidimensional data including spatial information; enables a balance to be struck between low-power monitoring and on-demand high-speed data transferring; and allows simplified manual installation and less administrative effort.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A surveillance network system, comprising:
a plurality of simple nodes each including two or more environmental sensors, wherein individual simple nodes are configured to transfer environmental data collected by the two or more environmental sensors to a controller node via a low-power Internet of Things (IoT) communication channel and wherein individual simple nodes join the surveillance network system by sending;
a plurality of complex nodes each including at least one environmental sensor and at least one video or image sensor, wherein individual complex nodes are configured to transfer environmental data collected by the at least one environmental sensor to the controller node via the low-power IoT communication channel; and
the controller node configured to transmit commands to individual simple or complex nodes via the low-power IoT communication channel, wherein a command transmitted via the low-power IoT communication channel to at least one complex node causes the at least one complex node to:
capture detailed data by the at least one video or image sensor, wherein the detailed data is larger in size than the environmental data; and
transfer the detailed data to the controller node via a high-speed communication channel, wherein the high-speed communication channel has a higher data transfer rate and higher power consuming rate than the low-power IoT communication channel.

2. The system of claim 1, wherein the controller node is further configured to determine a spatial distance between the controller node and one or more of the simple or complex nodes.

3. The system of claim 2, wherein determining the spatial distance comprises determining the spatial distance based at least partly on sound or radio frequency (RF) signals broadcasted by the one or more simple or complex nodes.

4. The system of claim 1, wherein the low-power IoT communication channel implements at least one of ZigBee, Bluetooth Low-Energy (BLE), Sub-1 GHz or Z-Wave protocols.

5. The system of claim 1, wherein a simple node or complex node acts as a routing node for the low-power IoT communication channel and wherein a complex node acts as a routing node for the high-speed communication channel.

6. The system of claim 1, wherein the environmental data includes at least data of temperature, sound, or motion.

7. The system of claim 1, wherein the environmental sensors include at least one of a passive infrared (PIR) sensor, PIR sensor array, or a sound sensor.

8. The system of claim 1, wherein the controller node includes at least one of an environmental sensor, image sensor, or video sensor.

9. The system of claim 1, wherein the controller node is further configured to communicate with one or more web services.

10. The system of claim 1, wherein individual complex nodes are further configured to, in response to a change in the environmental data collected by the at least one environmental sensor:
capture detailed data by the at least one video or image sensor; and
transfer the detailed data to the controller node via the high-speed communication channel.

11. A computer-implemented method for managing a surveillance network including one or more simple nodes, one or more complex nodes and at least one controller node, comprising:
receiving, at the controller node, environmental data transferred via a first communication channel from a simple node, wherein the simple node is configured to transfer data exclusively via the first communication channel;
receiving, at the controller node, environmental data transferred via the first communication channel from a complex node, wherein the complex node is configured to transfer data via the first communication channel or a second communication channel;
communicating, from the controller node to one or more web services via a third communication channel;
assigning the controller node to a current network topology;
determining a spatial distance between the current network topology and each of a first subset of simple or complex nodes;
selecting a first simple or complex node from the first subset of simple or complex nodes to join the current network topology, wherein the first simple or complex node has a shortest distance to the current network topology among all nodes of the first subset;
transmitting commands to individual simple or complex nodes via the first communication channel; and
in response to transmission of a command to at least one complex node, receiving, at the controller node, surveillance data transferred via the second communication channel from the at least one complex node.

12. The method of claim 11, wherein determining a spatial distance between the current network topology to each of a first subset of simple or complex nodes comprises determining the spatial distance based at least partly on sound or radio frequency (RF) signals broadcasted by the one or more simple or complex nodes.

13. The method of claim 11, further comprising:
determining a spatial distance between the current network topology and each of a second subset of simple or complex nodes, wherein the current network topology includes the controller node and the first simple or complex node; and
selecting a second simple or complex node from the second subset of simple or complex nodes to join the current network topology, wherein the second simple or complex node has a shortest distance to the current network topology among all nodes of the second subset.

14. The method of claim 13, wherein determining a spatial distance between the current network topology and each of a second subset of simple or complex nodes comprises, for each node in the second subset, selecting a shorter distance between (1) a distance between the node in the second subset and the controller node and (2) a distance between the node in the second subset and the first simple or complex node.

15. The method of claim 11, further comprising implementing one or more surveillance applications utilizing the environmental data or the surveillance data.

16. The method of claim 15, wherein the implementation of the one or more surveillance applications is further based on the communication from the controller node to the one or more web services via the third communication channel.

17. A non-transitory computer-readable medium storing computer-executable instructions that, when executed by one or more processors, cause the one or more processors to perform operations, the operations comprising:
collecting, at a complex node including at least a first sensor and a second sensor, first data captured by the first sensor;
transferring, from the complex node to a controller node, the collected first data via a first communication channel; and
in response to detecting a change in the collected first data:
activating the second sensor;
collecting, at the complex node, second data captured by the second sensor, wherein the second data is orders of magnitude greater than the first data; and
transferring, from the complex node to the controller node, the collected second data via a second communication channel.

18. The computer-readable medium of claim 17, wherein the second sensor has a higher power consuming rate than the first sensor.

19. The computer-readable medium of claim 17, wherein the controller nodes select the complex node to act as a routing node between another complex node and the controller node.

20. The computer-readable medium of claim 19, wherein the complex node acts as the routing node in at least one of the first or second communication channel.
